(19) United States
(12) Patent Application Publication
(10) Pub. No.: US 2010/0159067 A1
(43) Pub. Date: Jun. 24, 2010

(54) Hydrolyzed liquid sweetener for livestock

(75) Inventors: Bill L. Miller, Fort Dodge, IA (US); Mike Burr, Marthasville, MO (US); Robert C. Musser, Woodbury, MN (US); Madhu Kakade, Roseville, MN (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: Land O'Lakes Purina Feed LLC, Shoreview, MN (US)

(21) Appl. No.: 12/718,360

(22) Filed: Mar. 5, 2010

Related U.S. Application Data
(62) Division of application No. 12/099,867, filed on Apr. 9, 2008.

(51) Int. Cl. A23K 1/16; A23K 1/00

(52) U.S. Cl. 426/2; 426/271; 426/302

(57) ABSTRACT

The present invention includes a liquid sweetener made from a lactose containing liquid that can be used to coat animal feed to increase palatability. It also includes methods of making the liquid sweetener and making animal feed with increased palatability. The methods include hydrolyzing whey or whey derivatives and adding amino acids to promote a Maillard reaction to synthesize the sweetener.

### CROSS-REFERENCE TO RELATED APPLICATION

The present application is a divisional of and claims priority of U.S. patent application Ser. No. 12/099,867, filed Apr. 9, 2008, the content of which is hereby incorporated by reference in its entirety.

### FIELD OF THE INVENTION

The present invention relates to sweeteners for animal feed, and in particular, to the use of a lactose based liquid sweetener.

### BACKGROUND OF THE INVENTION

The addition of sweeteners to animal feed is an old and well-known method of inducing animals to intake more food, or to intake food that is not especially palatable. It is desirable that such sweeteners be low cost so that the cost of the animal feed is not substantially increased, if at all.

One such sweetener that has been used extensively in the past is molasses. Molasses has been used in attempts to make palatable animal feeds from agricultural bi-products which are generally considered not palatable. For example, molasses has been used to coat seed hulls such as sunflowers. A process to impregnate oat hulls with molasses is described in U.S. Pat. No. 3,395,019.

The rising cost of molasses is a concern for the animal feed industry. In addition, the molasses containing feeds can vary in appearance depending on the source and the batch of molasses used.

Whey, a cheese by-product of considerable proportion, has been used as an animal feed or animal feed supplement. Whey is used extensively as a food additive. Whey's two largest constituents, proteins and lactose, are removed from the whey for use as food additives. The Thomas U.S. Pat. No. 4,001,198 describes a method of recovering nutrients from cheese whey by sequential ultrafiltration, each ultrafiltration step removing as permeate substantial amounts of water and dissolved solids from the respective concentrates. Initially, protein is removed from the whey, then the lactose is removed from the permeate.

Miller et al. in U.S. Pat. No. 5,213,826 describes methods for making a whey permeate derived dry sweetener. This method includes using condensed whey permeate that is partially caramelized and has a lactose level of at least about 79% on a dry matter basis.

### SUMMARY OF THE INVENTION

The present invention includes a method of making a liquid sweetener for animals. The method includes adding amino acids and/or protein to a lactose containing liquid, hydrolyzing the lactose containing liquid and heating the liquid to adjust the moisture content to greater than about 15%. The lactose containing liquid may be hydrolyzed prior to adding of the amino acids or protein. The hydrolysis may be acid or alkaline hydrolysis. The lactose containing liquid can be any liquid containing lactose. The lactose containing liquid can be a whey derivative such as whey permeate or delactosed whey permeate or lactose in distiller solubles. The method can further include mixing the sweetener with oil, preferably at a ratio of about 5:2, respectively. The pH of the sweetener may also be adjusted.

In another aspect, the present invention includes a method of increasing palatability of animal feed. The method includes coating animal feed with a liquid sweetener wherein the liquid sweetener includes a hydrolyzed whey derivative combined with amino acids and/or proteins and heated to form the liquid sweetener having a moisture content of at least about 15%. The method can further include mixing the liquid sweetener with soy oil prior to coating the animal feed.

In a further aspect, the present invention includes a method of feeding animals by coating animal feed with a liquid sweetener wherein the liquid sweetener includes hydrolyzed whey derivative combined with amino acids and/or proteins and heated to form the liquid sweetener having a moisture content of at least about 15%. The method can further comprise mixing the liquid sweetener with soy oil prior to coating the animal feed.

In yet another aspect, the present invention includes a liquid sweetener for animal feed. The sweetener includes hydrolyzed and heated product obtained from combining whey derivative with amino acids and/or proteins, wherein the lactose content is less than about 40% and the moisture content of the sweetener is greater than about 15%. The sweetener can further include any type of oil. One suitable oil is soy oil. In some embodiments, the whey derivative is hydrolyzed prior to combining with amino acids and/or proteins. The whey derivative is preferably whey permeate or delactosed whey permeate. Preferably, the pH of the sweetener is between about 4.0 and 8.0 and the moisture content is less than about 60%.

In yet a further aspect, the present invention includes an animal feed treated with a liquid sweetener, wherein the liquid sweetener includes hydrolyzed and heated product obtained from combining whey derivative with amino acids and/or proteins, wherein the lactose content is less than about 40% and the moisture content of the sweetener is greater than about 15%, the liquid sweetener combined with an oil prior to treating the animal feed. The animal feed can include at least one or more of corn, oat, sunflower seeds and derivatives therefrom. The animal feed can be calf feed.

### DETAILED DESCRIPTION OF ILLUSTRATIVE EMBODIMENTS

The present invention includes liquid sweeteners obtained from lactose containing liquids such as whey. However, any type of lactose containing liquid may be used. By whey, it is meant whey and any derivatives obtained from whey after it has been processed, for example, by ultrafiltration. The terms “whey” and “whey derivatives” may be used interchangeably herein. The lactose present in the whey is generally hydrolyzed and the resulting sugars react with amino acids and/or proteins when heated to produce a browned liquid. Further heating of the liquid to reduce the moisture content results in a liquid sweetener of desired consistency. The liquid sweetener is then, preferably mixed with oil prior to being used to coat animal feed. The liquid sweeteners and the animal feed coated with these liquid sweeteners have increased palatability to animals.

The present invention includes methods of making a liquid sweetener for animals by hydrolyzing whey and whey derivatives. The whey derivatives preferably are whey permeate or delactosed whey permeate. By whey permeate, it is meant the permeate that is obtained after whey is subjected to an ultrafiltration step in which a substantial amount of protein is removed. By delactosed whey permeate, it is meant the permeate that is obtained after whey permeate is subjected to an ultrafiltration step in which some lactose is removed. Other processes for obtaining a delactosed whey include evaporation and reverse osmosis. A significant amount of lactose is still present in the delactosed whey permeate.

The hydrolysis of whey and whey derivatives may be acid catalyzed hydrolysis. Alternatively, hydrolysis may be base catalyzed hydrolysis. During hydrolysis, lactose, which is a disaccharide, is cleaved to form two monosaccharides. Generally, hydrolysis of lactose results in formation of reducing sugars glucose and galactose. The products from hydrolysis are generally heated in the presence of amino acids and/or peptides to promote a Maillard reaction. In some embodiments, ethanol solubles are added as a source of amino acids. Ethanol solubles are a bi-product from the production of ethanol from corn.

In some embodiments, the whey derivative is hydrolyzed and then amino acids are added and the mixture heated to promote the Maillard reaction. In alternative embodiments, the whey derivative is combined with amino acids, prior to hydrolysis, and then the combination is heated to hydrolyze and promote the Maillard reaction.

Maillard reaction, as used herein, is a chemical reaction between an amino acid and a reducing sugar usually requiring heat. Maillard reaction results in non-enzymatic browning of the product and is different from caramelization in that the Maillard reaction utilizes amino acids whereas caramelization involves oxidation of sugars. In other words, caramelization does not require the presence of amino acids. The Maillard reaction results in formation of a number of flavor compounds.

After the Maillard reaction, the pH of the mixture may be adjusted, preferably, to about 5.0 in an acidic hydrolysis and to about 8.0 in an alkaline hydrolysis. The mixture may be heated under vacuum again to reduce the moisture content to the desired level. The hydrolyzed liquid sweetener may be stored in a container until applied to animal feed. Alternatively, the hydrolyzed liquid sweetener may be combined with an oil, preferably soy oil, before being applied to animal feed.

In another aspect, the present invention includes animal feed incorporated with the liquid sweetener derived from the whey derivatives. Preferably, the animal feed is coated with the liquid sweetener that has been combined with oil prior to coating animal feed. The animal feed can include, for example, corn and corn derivatives, oats and oat derivatives.

In a further aspect, the present invention includes a method of increasing palatability of animal feed. The method includes incorporating the liquid sweetener into the animal feed. Preferably, the method includes coating animal feed with the liquid sweeteners of the present invention.

In another aspect, the present invention includes a method of feeding animals by incorporating the liquid sweetener into the animal diet. Preferably, the method includes coating animal feed with the liquid sweeteners of the present invention.

A variety of whey derivatives can be used in making the liquid sweeteners of the present invention. In some embodiments, whey permeate is used as the whey derivative. In other embodiments, delactosed whey permeate is used. Suitable whey derivatives are preferably in a liquid form. The whey derivatives generally contain at least about 10 percent lactose and less than about 40 percent of lactose.

An amino acid source, such as proteins, are generally added to the whey derivative. Alternatively, individual desired amino acids may be added to the whey derivative. The proteins added can be from any number of sources, such as plant derived proteins, animal derived proteins and the like. In some embodiments, the proteins are derived from milk. Condensed Distillers Solubles (CDS) is one source of proteins although any source of protein is acceptable. The amount of amino acids and/or proteins added to the whey derivative can vary. Suitable amounts can be between about 0.5% and about 20% with 0.8% being one suitable amount.

### Acid Hydrolysis

The lactose in the whey derivative may be hydrolyzed by acid catalyzed hydrolysis. A variety of acids may be suitable to induce hydrolysis of the lactose and include, for example, phosphoric acid. However any strong acid such as sulfuric or hydrochloric is also suitable. These acids should be non-toxic and compatible for ingestion by animals when the liquid sweetener derived from this reaction is used to coat animal feed. The amount of acid used depends on the target pH and the amount of material to be hydrolyzed. Some production of maltose occurs during this process.

After addition of the acid, the whey derivative is heated. The temperature and the length of heating can vary and may be adjusted to achieve the desired amount of hydrolysis. The whey derivative is preferably heated to at least about 270° F. More preferably, the whey derivative is heated to between about 290° F. to about 300° F. Most preferably the whey derivative is heated to between about 250° F. to about 320° F. In some embodiments, the heating is conducted in a pressure cooker. The whey derivative is preferably heated under pressure. The amount of time required depends on the processing temperature, as pressure increases time may be decreased. The whey derivative is preferably heated for at least about 3 minutes. Most preferably, the whey derivative is heated for about 10 minutes.

In the present invention, an amino acid or protein source is generally added to the hydrolyzed whey derivative. The pH of the whey derivative is, preferably, adjusted to between about 4.0 and about 6.0, more preferably to about 5.0. The pH is generally adjusted by the addition of Sodium Hydroxide although other suitable bases may also be used. The whey derivative may be heated further to drive off more of the moisture until the desired moisture level or consistency is attained and a brown liquid is formed.

### Alkaline Hydrolysis

In alkaline hydrolysis, the whey derivative is generally mixed with the amino acid or protein source. The pH of the whey derivative is preferably adjusted to between about pH 8.0 and about pH 11.0. Most preferably, the pH of the whey derivative is adjusted to about 10.0. Preferably the pH is adjusted by the addition of sodium hydroxide, although other suitable bases may be used.

After adjusting the pH, the whey derivative is heated. The temperature and the length of heating can vary and may be adjusted to achieve the desired amount of hydrolysis. The whey derivative is preferably heated to at least about 270° F. More preferably, the whey derivative is heated to between about 290° F. to about 300° F. Most preferably the whey derivative is heated to between about 250° F. to about 320° F. In some embodiments, the heating is conducted in a pressure cooker. In alternative embodiments, the heating is conducted under a vacuum. The heating can be conducted using a continuous flow coil. The whey derivative is preferably heated for at least about 7 minutes at 295° or higher. Most preferably, the whey derivative is heated for about 10 minutes

After hydrolysis, the pH of the liquid is, preferably, adjusted to between about 4.0 and about 8.0, more preferably to about 7.0. Any suitable acid may be used to adjust the pH. In preferred embodiments, phosphoric acid was used to adjust the pH. The liquid may be heated further to drive off more of the moisture until the desired moisture level or consistency is attained as described above for acid hydrolysis and a brown liquid is formed.

The liquid sweeteners made by the methods described above have desired palatability and consistency. The moisture content of the liquid sweetener is at least about 15%. Preferably, the moisture content of the liquid sweetener is between about 20% and about 50% and is typically 35%. The liquid sweetener is heated until the desired moisture content is reached. In a continuous process an inline moisture meter is used.

The lactose concentration in the liquid sweetener is 10% or less.

The liquid sweeteners of the present invention may be formulated to coat animal feed. Suitable methods for formulating liquid sweeteners are known in the art and can include, for example, mixing the sweetener with an oil. In preferred embodiments, the oil is a soy oil. The ratio of the sweetener to the oil can vary and depend on the viscosity of the sweetener and the oil. One exemplary ratio is about five parts sweetener to about two parts oil.

The liquid sweetener and feed coated with the liquid sweetener are suitable for a variety of animals. These animals include livestock such as cows, pigs and horses. This liquid sweetener may also be suitable for coating food for other animals which are all within the scope of the invention.

The following Examples are included to illustrate the present invention and are not intended to limit the invention in anyway.

### EXAMPLES

### Example 1

### Production of Liquid Sweeteners

Whey permeate or delactosed whey permeate were used to produce different sweeteners. The different products were evaluated to determine the preference by calves to them in relation to cane molasses.

Two main pieces of equipment were used for producing the liquid sweeteners. A 1-gallon Waring blender was used to agitate the product while pH adjustments were being made to allow for an accurate measurement. A Sauciers's double planetary mixer equipped with 60 psi steam jacket and vacuum pump was modified to be a pressure cooker as opposed to a vacuum cooker by fitting a clamp bracket around the flange to hold kettle to the head of the vessel while under pressure. The vacuum port was sealed off and fitted with a ball valve that was used to relieve pressure at the end of the hydrolysis cycle. By making these changes, it was possible to achieve 30 psi in the kettle and raise the temperature of the product above its boiling point at atmospheric pressure. A 5-gallon Meyers mixer was used to mix the finished liquid and soy oil product prior to applying the coarse ingredients

Five liquids, as shown in Table 1, were produced using the processing sequence indicated to manufacture the liquid. The ingredients used and the percentages by weight are also shown in Table 1.

TABLE 1

| Liquid | AP5 | ALP8 | ALP5 | ADP5 | ALDP5 |
|---|---|---|---|---|---|
| Nomenclature | | | | | |
| Acid Hyd. | x | | | x | |
| Alkaline Hyd. | | x | x | | x |
| Permeate | x | x | x | | |
| De-lact. permeate | | | | x | x |
| Target final pH | 5.0 | 8.0 | 5.0 | 5.0 | 5.0 |
| Processing Seq. | | | | | |
| Initial Ingred., % | | | | | |
| Permeate | 73.1 | 83.7 | 84.3 | | |
| De-lactose Perm. | | | | 66.9 | 82.0 |
| Ethanol Sol. | | 14.1 | 14.0 | | 13.6 |
| NaOH | | 1.4 | 1.4 | | 3.0 |
| Phos. Acid | 8.5 | | | 12.9 | |
| Heat product | x | x | x | x | x |
| Add Ingredients | | | | | |
| Ethanol Solubles | 12.1 | | | 11.2 | |
| NaOH | 6.3 | 0.8 | | 9.0 | |
| Phos. Acid | | | 0.3 | | 1.4 |
| Dehydrate | x | x | x | x | x |

AP5—The cooking process was started by blending permeate and phosphoric acid in the Waring blender. The material was heated in the Sauciers's kettle to 295° F. for 10 minutes to hydrolyze the lactose. At the end of the reaction, the ethanol solubles were added. The pH was adjusted to 5.0 in the Waring blender with NaOH. A final heating step was used to drive moisture off of the product in the Sauciers's mixer. After the desired amount of water was removed, the product was placed in a 5-gallon bucket for storage.

ALP5—Permeate and ethanol solubles were adjusted to pH 9.0 with NaOH in the Waring blender. The material was heated in the Sauciers's kettle to 295° F. for 10 minutes to hydrolyze the lactose. The pH was adjusted to 5.0 in the Waring blender with Phosphoric acid. A final heating step was used to drive moisture off of the product in the Sauciers's mixer. After the desired amount of water was removed, the product was placed in a 5-gallon bucket for storage.

ALP8—Permeate and ethanol solubles were adjusted to pH 9.0 with 50% NaOH in the Waring blender. The material was heated in the Sauciers's kettle to 295° F. for 10 minutes to hydrolyze the lactose. The pH was adjusted to 8.0 in the Waring blender with 50% NaOH. A final heating step was used to drive moisture off of the product in the Sauciers's mixer. After the desired amount of water was removed, the product was placed in a 5-gallon bucket for storage.

ADP5—This product was made using the same procedure as AP5 with the exception that de-lactose whey permeate was used in place of permeate.

ALDP5—This product was made using the same procedure as ALP5 with the exception that de-lactosed whey permeate was used to replace permeate.

Each liquid was assayed and the results shown in Table 2.

TABLE 2

Liquid

| Assay Results | AP5 | ALP8 | ALP5 | ADP5 | ALDP5 |
|---|---|---|---|---|---|
| Moisture | 34.0 | 42.3 | 39.9 | 37.6 | 38.1 |
| Ash | 15.6 | 7.54 | 7.43 | 19.5 | 14.1 |
| pH | 5.63 | 5.52 | 5.35 | 5.36 | 7.11 |
| Fructose | <1.0 | <1.0 | <1.0 | <1.0 | <1.0 |
| Glucose | 9.08 | <1.0 | <1.0 | 5.67 | <1.0 |
| Sucrose | <1.0 | <1.0 | <1.0 | <1.0 | <1.0 |
| Maltose | <1.0 | 15.0 | 16.8 | <1.0 | 9.14 |
| Lactose | 8.43 | 20.7 | 18.4 | 3.41 | 13.2 |

Adjusting the pH upwardly of the product after hydrolysis resulted in a reaction that tended to foam and splash during the NaOH addition. The three products made with alkaline hydrolysis were easier to manufacture and also required less NaOH and Phosphoric acid to achieve the desired pH levels during processing. There was no processing difference when using either de-lactosed permeate or whey permeate. Multiple batches of the liquids were produced and combined to make product for the calf starters.

### Example 2

Each of the five manufactured liquids from Example 1 were used to make a liquid that was formulated like the Dairy Processed Molasses product used currently on calf starters and then used to coat coarse rations. These products were made in the 5-gallon Meyers mixer equipped with the high shear heads.

Mixing procedure-Experimental liquid and water were blended for 30 seconds. TSPP and Attapulgite clay were added and blended for an additional 2 minutes. Soy oil was added to the mixture and blended for 30 seconds. Phosphoric acid and Propionic acid were added and blended for 2 minutes. The products were poured as coarse rations in the 250 lb ribbon mixer. The finished product was placed in poly lined bags until fed to calves.

| Ingredient | % |
|---|---|
| Clay | 1.100 |
| Phosphoric Acid | 1.000 |
| Water | 5.750 |
| Soy Oil | 10.000 |
| Propionic Acid | 1.000 |
| TSPP | 0.200 |
| Hydrolized Permeate | 80.950 |

This preference trial assesses the various versions of a liquid permeate sweetener (with or without lactose and treated with various pH levels) on a textured calf starter.

The trial was conducted for 6 days. Forty calves were weaned on an 18% basal, textured diet, consisting of cracked corn and pellet with no molasses. Table 3 indicates the treatments (the two types of feed) each group of calves were offered.

TABLE 3

| | | B. No. of |
|---|---|---|
| Treatment No. | A. Starter Description | Calves |
| CT-14-06-1-Red | Control, texturized calf starter w/7% liquid molasses^{A} (LM7) | 8 |
| CT-14-06-2-Blue | As #1 w/7% Permeate, acid hydrolyzed, pH 5.0^{B} (AP5) | |
| CT-14-06-1-Red | Control (LM7) | 8 |
| CT-14-06-3-Green | As #1 w/7% Permeate, alkaline hydrolyzed, pH 5.0^{C} (ALP5) | |
| CT-14-06-1-Red | Control (LM7) | 8 |
| CT-14-06-4-Orange | Delactosed permeate, acid hydrolyzed, pH 5.0^{D} (ADP5) | |
| CT-14-06-1-Red | Control (LM7) | 8 |
| CT-14-06-5-Gray | Delactosed permeate, alkaline hydrolyzed, pH 5.0^{E} (ALDP5) | |
| CT-14-06-1-Red | Control (LM7) | 8 |
| CT-14-06-6-Yellow | Permeate, alkaline hydrolyzed, pH 8.0^{F} (ALP8) | |

^{A}Current liquid molasses blend (5 parts cane molasses:2 parts soy oil).
^{B}Acid hydrolyzed - pH 5 adjusted (5 parts permeate:2 parts soy oil).
^{C}Alkaline hydrolyzed - pH 5 adjusted (5 parts permeate:2 parts soy oil).
^{D}Acid hydrolyzed - pH 5 adjusted (5 parts delactosed permeate:2 parts soy oil).
^{E}Alkaline hydrolyzed - pH 5 adjusted (5 parts delactosed permeate:2 parts soy oil).
^{F}Alkaline hydrolyzed - pH 8 adjusted (5 parts permeate:2 parts soy oil).

Test feeds were offered at 10:00 AM to 2:00 PM daily. Locations of test feeds were switched daily. Water and average (bland) calf starter was offered in ad libitum (˜3.0 lbs) amounts. Location of water buckets and bland calf starter was switched from 2:00 PM to 10:00 AM each time. The same amount of each of the starters (4.0 lbs) was offered to each individual calf in amounts sufficient so it will not all be consumed. Daily feed weigh back was recorded and converted to consumption. Data was analyzed by t-test, a statistical test that compares the means of two groups of observations.

Results are shown in Table 4. The comparison between calves with a choice between liquid molasses and acid hydrolyzed permeate—pH 5 (AP5) will be referred to as comparison A. The comparison between calves with a choice between liquid molasses and alkaline hydrolyzed permeate—pH 5 (ALP5) will be referred to as comparison B. The comparison between calves with a choice between liquid molasses and acid hydrolyzed delactose permeate—pH 5 (ADP5) will be referred to as comparison C. The comparison between calves with a choice between liquid molasses and alkaline hydrolyzed delactosed permeate—pH 5 (ALDP5) will be referred to as comparison D. The comparison between calves with a choice between liquid molasses and alkaline hydrolyzed permeate—pH 8 (ALP8) will be referred to as comparison E.

TABLE 4

| | | Consumption | | | |
|---|---|---|---|---|---|
| | | lbs/hd/day | Preference | | Preference |
| Comparison | Treatment No. | (As fed basis) | Ratio^{A} | P-value | Incidence^{B} |
| A | CT-14-06-1-Red^{C} | 0.09 | 11.34:1.00 | <0.0001 | 0 |
| | CT-14-06-2-Blue^{D} | 0.98 | | | 100 |
| B | CT-14-06-1-Red | 0.04 | 24.12:1.00 | <0.0001 | 0* |
| | CT-14-06-3-Green^{E} | 0.94 | | | 94* |
| C | CT-14-06-1-Red | 0.11 | 10.37:1.00 | <0.0001 | 2 |
| | CT-14-06-4-Orange^{F} | 1.14 | | | 98 |
| D | CT-14-06-1-Red | 0.34 | 1.87:1.00 | 0.0341 | 29* |
| | CT-14-06-5-Gray^{G} | 0.67 | | | 67* |
| E | CT-14-06-1-Red | 0.20 | 3.46:1.00 | <0.0001 | 5 |
| | CT-14-06-6-Yellow^{H} | 0.68 | | 1 | 85 |

^{A}Determined by dividing the intake of the preferred product by that of the less preferred product.
^{B}Percent of feedings that calves preferred each product.
^{C}Control, texturized calf starter w/7% liquid molasses (LM7). Current liquid molasses blend (5 parts cane molasses:2 parts soy oil).
^{D}As #1 w/7% Permeate, acid hydrolyzed, pH 5.0 (AP5). Acid hydrolyzed - pH 5 adjusted (5 parts permeate:2 parts soy oil).
^{E}As #1 w/7% Permeate, alkaline hydrolyzed, pH 5.0 (ALP5). Alkaline hydrolyzed - pH 5 adjusted (5 parts permeate:2 parts soy oil).
^{F}Delactosed permeate, acid hydrolyzed, pH 5.0 (ADP5). Acid hydrolyzed - pH 5 adjusted (5 parts delactosed permeate:2 parts soy oil).
^{G}Delactosed permeate, alkaline hydrolyzed, pH 5.0 (ALDP5). Alkaline hydrolyzed - pH 5 adjusted (5 parts delactosed permeate:2 parts soy oil).
^{H}Permeate, alkaline hydrolyzed, pH 8.0 (ALP8). Alkaline hydrolyzed - pH 8 adjusted (5 parts permeate:2 parts soy oil).
*Both percentages added not equal to 100 due to ties.

Calves in comparison A consumed more, had a better preference ratio and improved percent preference incidence for AP5 (P<0.0001). Calves offered test feed in comparison B had greater intakes, had a better preference ratio and improved percent preference incidence for ALP5 (P<0.0001). Calves in comparison C consumed more, had a better preference ratio and improved percent preference incidence for ADP5 (P<0.0001). Calves involved in comparison D had higher intakes, had a better preference ratio and improved percent preference incidence for ALDP5 (P=0.0341). Calves in comparison E consumed more, had a better preference ratio and improved percent preference incidence for ALP8 (P<0.0001).

Calf intakes, preference ratio and preference incidence favored (P<0.0001) the test feeds for comparisons A, B, C, E. Calf intakes, preference ratio and preference incidence favored (P=0.0341) the test feeds in comparison D. No test feed product caused any health concerns.

### Example 3

In this example the effects of using lower levels of the liquid sweeteners to coat calf feed is shown along with comparisons to calf feed coated with an alternative liquid coating that does not contain molasses and also a processed molasses.

Two liquid sweeteners using whey permeate were produced using the procedure described in Example 1 above. Table 5 shows the actual percentages of ingredients used to make these liquids. The source of the protein for the Maillard reaction was Condensed Distillers Solubles from Ethanol production (CDS).

TABLE 5

| Liquid | AP5 | ALP5 |
|---|---|---|
| Nomenclature | | |
| Acid Hyd. | x | |
| Alkaline Hyd. | | x |
| Permeate | x | x |
| Target Final pH | 5.0 | 5.0 |
| Processing Sequence | | |
| Initial Ingredients, % | | |
| Permeate | 72.0 | 8.43 |
| CDS | | 14.0 |
| NaOH | | 1.4 |
| Phos. Acid | 9.3 | |
| Heat product | x | x |
| Add ingredients | | |
| CDS | 12.1 | |
| NaOH (50) | 6.6 | |
| Phos Acid | | 0.3 |
| Dehydrate | x | x |

AP5 and ALP5 were assayed for content and the results are shown below in Table 6.

TABLE 6

Liquid

| Assay Results | AP5 | ALP5 |
|---|---|---|
| Moisture | 31.0 | 27.9 |
| Ash | 3.00 | 4.45 |
| pH | 5.69 | 5.68 |
| Fructose | 0.40 | <0.2 |
| Glucose | 1.11 | <0.2 |
| Sucrose | <0.2 | <0.2 |
| Maltose | 0.59 | 10.2 |
| Lactose | 8.61 | 25.3 |

Table 7 below shows the coarse ration products that were made to feed the calves. SC75-2 and SC68-5 are Super coat 75-2 and Super coat 68-5, respectively, which are processed molasses obtained from Quality Liquid Feeds, La Salle, Ill. RS-F is a Rumasweet® concentrate product produced by C.K. Processing, Muscatine, Iowa. The Rumasweet® concentrate product is also described in U.S. Pat. Nos. 5,009,899 and 5,213,826.

TABLE 7
Coarse Ration Products:

| Ingredient % | DPM 7% | ALP5 7% | ALP5 3.5% | ALP5 1.75% | AP5 7% | SC 75-2 | SC 68-5 | RS F-Cow |
|---|---|---|---|---|---|---|---|---|
| Pellets no RS | 50.000 | 50.000 | 50.000 | 50.000 | 50.000 | 50.000 | 50.000 | |
| Pellets w/RS | | | | | | | | 50.000 |
| Corn | 30.380 | 30.380 | 33.880 | 35.630 | 30.380 | 30.380 | 30.380 | 34.380 |
| Oats | 12.470 | 12.470 | 12.470 | 12.470 | 12.470 | 12.470 | 12.470 | 12.470 |
| DPM | 7.000 | | | | | | | 3.000 |
| AlP5 | | 7.000 | 3.500 | 1.750 | | | | |
| AP5 | | | | | 7.000 | | | |
| SC75-2 | | | | | | 7.000 | | |
| SC68-5 | | | | | | | 7.000 | |
| Ultra Curb | 0.150 | 0.150 | 0.150 | 0.150 | 0.150 | 0.150 | 0.150 | 0.150 |
| Total | 100.000 | 100.000 | 100.000 | 100.000 | 100.000 | 100.000 | 100.000 | 100.000 |

The Whey permeate (containing lactose) and CDS that were used to make the liquid sweeteners were assayed for content of moisture, protein and sugars. Results are shown below in Table 8.

TABLE 8

| | Whey | CDS |
|---|---|---|
| Moisture | 63.4 | 72.3 |
| Protein | 2.24 | 5.00 |
| Fat | <0.1 | 4.80 |
| pH | 5.48 | 3.36 |
| Sugars | | |
| Fructose | <0.2 | <0.2 |
| Glucose | <0.2 | 0.27 |
| Sucrose | <0.2 | <0.2 |
| Maltose | <0.2 | 0.22 |
| Lactose | 25.7 | <0.2 |

The preference trial assesses the merit of a liquid RumaSweet® and Alkaline Hydrolyzed Delactosed Permeate (pH 5.0) (ALDP5) in a titration. The control was a Dairy Processed Molasses (DPM). The trial was conducted for 6 days. Forty Two calves previously were weaned on an 18% basal, textured diet, consisting of cracked corn and pellet with no molasses. Table 9 indicates the treatments (the two types of feed) each group of calves were offered. Test feeds were offered daily as described above in Example 2 and data analyzed by t-test.

TABLE 9

| | | D. No. of |
|---|---|---|
| Treatment No. | C. Starter Description | Calves |
| CT-20-06-1-Red | Control, texturized calf starter w/7% liquid molasses^{A} (DPM7) | 6 |
| CT-20-06-2-Blue | As #1 w/7% Permeate, alkaline hydrolyzed, pH 5.0^{B} (ALP5) | |
| CT-20-06-1-Red | Control (DPM7) | 6 |
| CT-20-06-3-Green | As #1 w/3.5% Permeate, alkaline hydrolyzed, pH 5.0^{B} (ALP5) | |
| CT-20-06-1-Red | Control (DPM7) | 6 |
| CT-20-06-4-Orange | As #1 w/1.75% Permeate, alkaline hydrolyzed, pH 5.0^{B} (ALP5) | |
| CT-20-06-2-Blue | As#1 w/7% Permeate, alkaline hydrolyzed^{B}, pH 5.0 (ALP5) | 6 |
| CT-20-06-5-Black | As#1 w/7% Permeate, acid hydrolyzed^{C}, pH 5.0 (AP5) | |
| CT-20-06-1-Red | Control (DPM7) | 6 |
| CT-20-06-6-Gray | As #1 w/7% SC 75-2^{D} | |
| CT-20-06-1-Red | Control (DPM7) | 6 |
| CT-20-06-7-Yellow | As #1 w/7% SC 68-5^{E} | |
| CT-20-06-1-Red | Control (DPM7) | 6 |
| CT-20-06-8-Purple | Future Cow ® (from Land O'Lakes Purina Feed LLC of Arden Hills, | |
| | MN) w/RS and 7% DPM^{F} | |

^{A}Current liquid molasses blend (80% cane molasses, 10% soy oil & 10% clay/preservation ingredients). DPM = Dairy Processed Molasses, 7% (DPM7).
^{B}Alkaline hydrolyzed - pH 5 adjusted (80% permeate, 10% soy oil & 10% clay/preservation ingredients).
^{C}Acid hydrolyzed - pH 5 adjusted (80% permeate, 10% soy oil & 10% clay/preservation ingredients).
^{D}QLF liquid products, Super Coat 75-2 (75% DM 2% Fat).
^{E}QLF liquid products, Super Coat 68-5 (68% DM 5% Fat).
^{F}Dry textured starter w/Rumasweet ®. Future Cow ® Starter Base. Product contained 7% DPM to tie up ingredients.

Results are shown in Table 10. All feeds were textured. The comparison between calves with a choice between 7% liquid molasses and 7% alkaline hydrolyzed permeate—pH 5 will be referred to as comparison A. The comparison between calves with a choice between 7% liquid molasses and 3.5% alkaline hydrolyzed permeate—pH 5 will be referred to as comparison B. The comparison between calves with a choice between liquid molasses and 1.75% alkaline hydrolyzed permeate—pH 5 will be referred to as comparison C. The comparison between calves with a choice between 7% alkaline and 7% acid hydrolyzed permeate (both pH 5.0) will be referred to comparison D. The comparison between calves with a choice between 7% liquid molasses and QLF 7% SC 75-2 will be referred to as comparison E. The comparison between calves with a choice between 7% liquid molasses and QLF 7% SC 68-5 will be referred to as comparison F. The comparison between calves with a choice between 7% liquid molasses and Future Cow® Base w/ Rumasweet® and 3% liquid molasses will be referred to as comparison G.

Calves in comparison A, B and C consumed more, had a better preference ratio and improved percent preference incidence for 7%, 3.5% and 1.75% alkaline hydrolyzed permeate (P<0.0001) over the liquid molasses diet.

Calves offered test feed in comparison D had greater intakes, had a better preference ratio and improved percent preference incidence for 7% acid hydrolyzed permeate (P=0.0045) over 7% alkaline hydrolyzed permeate.

Calves in comparison E consumed more, had a better preference ratio and improved percent preference incidence for liquid molasses (P<0.0006) over QLF 7% SC 75-2. It should be noted the weather was below freezing and the QLF 7% SC 75-2 containing feed set up like concrete and had to be dropped numerous times to break up the feed. When it finally thawed in the calf unit, it was very sticky.

Calves involved in comparison F had no preference (P=0.2425) between either liquid molasses or QLF 7% SC 68-5.

Seven percent DPM was employed to bind the product outside. Calves in comparison G consumed more, had a better preference ratio and improved percent preference incidence for liquid molasses (P<0.0005) over Future Cow® Base with Rumasweet® and 7% liquid molasses. Previous data with RumaSweet® has shown that RumaSweet® can be overwhelmed when too much liquid molasses is used as was this case.

TABLE 10

| | | Consumption | | | |
|---|---|---|---|---|---|
| | | lbs/hd/day | Preference | | Preference |
| Comparison | Treatment No. | (As fed basis) | Ratio^{A} | P-value | Incidence^{B} |
| A | CT-20-06-1-Red^{C} | 0.09 | 10.13:1.00 | <0.0001 | 2.8 |
| | CT-20-06-2-Blue^{D} | 0.93 | | | 97.2 |
| B | CT-20-06-1-Red | 0.04 | 20.70:1.00 | <0.0001 | 0* |
| | CT-20-06-3-Green^{E} | 0.78 | | | 97.2* |
| C | CT-20-06-1-Red | 0.07 | 10.07:1.00 | <0.0001 | 2.8 |
| | CT-20-06-4-Orange^{F} | 0.70 | | | 97.2 |
| D | CT-20-06-2-Blue | 0.33 | 2.04:1.00 | 0.0045 | 30.6 |
| | CT-20-06-5-Black^{G} | 0.67 | | | 69.4 |
| E | CT-20-06-1-Red | 0.56 | 2.99:1.00 | <0.0006 | 69.4* |
| | CT-20-06-6-Gray^{H} | 0.19 | | | 27.8* |
| F | CT-20-06-1-Red | 0.66 | 1.38:1.00 | 0.2425 | 55.6* |
| | CT-20-06-7-Yellow^{I} | 0.47 | | | 38.9* |
| G | CT-20-06-1-Red | 0.75 | 2.94:1.00 | <0.0005 | 77.8 |
| | CT-20-06-8-Purple^{J} | 0.26 | | | 22.2 |

^{A}Determined by dividing the intake of the preferred product by that of the less preferred product.
^{B}Percent of feedings that calves preferred each product.
^{C}Current liquid molasses blend (80% cane molasses, 10% soy oil & 10% clay/preservation ingredients). DPM = Dairy Processed Molasses, 7% (DPM7).
^{D}As #1 w/7% Permeate, alkaline hydrolyzed, pH 5.0, (80% permeate, 10% soy oil & 10% clay/preservation ingredients).
^{E}As #1 w/3.5% Permeate, alkaline hydrolyzed, pH 5.0, (80% permeate, 10% soy oil & 10% clay/preservation ingredients).
^{F}As #1 w/1.75% Permeate, alkaline hydrolyzed, pH 5.0, (80% permeate, 10% soy oil & 10% clay/preservation ingredients).
^{G}As#1 w/7% Permeate, acid hydrolyzed, pH 5.0, (80% permeate, 10% soy oil & 10% clay/preservation ingredients).
^{H}As #1 w/7% SC 75-2, QLF liquid products, Super Coat 75-2 (75% DM 2% Fat).
^{I}As #1 w/7% SC 68-5, QLF liquid products, Super Coat 68-5 (68% DM 5% Fat).
^{J}Future Cow w/RS and 7% DPM (should have been 3%), dry textured starter w/Rumasweet ®. Future Cow ® Starter Base
*Both percentages added not equal to 100 due to ties.

Calf intakes, preference ratio and preference incidence favored (P<0.0001) the test feeds for comparisons A, B and C over the liquid molasses diets. Calf intakes, preference ratio and preference incidence favored (P=0.0045) the acid hydrolyzed permeate test feed in comparison D over the alkaline hydrolyzed permeate diet. Calf intakes, preference ratio and preference incidence favored (P<0.0005) the liquid molasses feed in comparison E and G over the QLF 7% SC 75-2 and the molasses containing Future Cow® with Rumasweet®. The QLF Super Coat 75-2 set up badly when froze and was very sticky when thawed. Calves preferred liquid molasses and QLF SC 7% 68-5 equally (P=0.2425). Calves showed again when too much molasses (7%) is used with RumaSweet®, it can overcome the positive palatability of RumaSweet®.

No test feed product caused any health concerns.

### Example 4

Liquid sweetener ALDP5 was made with delactose whey permeate as the base using the procedure described above in Example 1. The specific percentage of ingredients used in this batch are shown in Table 11.

TABLE 11

| Liquid | ALDP5 |
|---|---|
| Nomenclature | |
| Alkaline Hyd. | x |
| Delactose Permeate | x |
| Target Final pH | 5.0 |
| Processing Sequence | |
| Initial Ingredients, % | |
| Delactose Permeate | 84.6 |
| Distiller Solubles | 14.0 |
| NaOH | 1.4 |
| Heat product | x |
| Dehydrate | x |

Coarse ration products were made using the ALDP5 at different concentrations or DPM as shown in Table 12.

TABLE 12
Course Ration Products:

| | DPM | ALDP5 | ALDP5 | ALDP5 |
|---|---|---|---|---|
| Ingredient % | 2% | 7% | 3.5% | 1.75% |
| Pellets | 50.000 | 50.000 | 50.000 | 50.000 |
| Omolene Corn | 30.380 | 30.380 | 33.880 | 35.630 |
| Oats | 12.470 | 12.470 | 12.470 | 12.470 |
| DPM | 7.000 | | | |
| ALDP5 | | 7.000 | 3.500 | 1.750 |

The preference trial assesses the various sweeteners on a textured calf sweetener. The trial was conducted for 6 days. Forty Eight calves previously were weaned on an 18% basal, textured diet, consisting of cracked corn and pellet with no molasses. Table 13 indicates the treatments (the two types of feed) each group of calves were offered. Test feeds were offered daily as described above in Example 2 and data analyzed by t-test.

TABLE 13

| | | | No. of |
|---|---|---|---|
| Comparison | Diet Name | Starter Description | Calves |
| 1 | CT-8-07-1-Red | Control, texturized calf starter w/7% liquid molasses^{A} (DPM7) | 8 |
| | CT-8-07-2-Blue | As #1 w/5% Rumasweet ®^{B}, (5.0% RS) | |
| 2 | CT-8-07-1-Red | Control (DPM7) | 8 |
| | CT-8-07-3-Green | As #1 w/3.75% Rumasweet ®^{B}, (3.75% RS) | |
| 3 | CT-8-07-1-Red | Control (DPM7) | 8 |
| | CT-8-07-4-Orange | As #1 w/2.5% Rumasweet ®^{B}, (2.5% RS) | |
| 4 | CT-8-07-1-Red | Control (DPM7) | 8 |
| | CT-8-07-5-Gray | As #1 w/7% Delactose Permeate, Alkaline (pH 5.0), (ALDP5^{C}) | |
| 5 | CT-8-07-1-Red | Control (DPM7) | 8 |
| | CT-8-07-6-Yellow | As #1 w/3.5% Delactose Permeate, Alkaline (pH 5.0), (ALDP5^{C}) | |
| 6 | CT-8-07-1-Red | Control (DPM7) | 8 |
| | CT-8-07-7-Purple | As #1 1.75% Delactose Permeate, Alkaline (pH 5.0), ALDP5^{C}) | |

^{A}Current liquid molasses blend (5 parts cane molasses:2 parts soy oil), DPM = Dairy processed molasses
^{B}Rumasweet ®, manufactured for LOLP Feed by C.K. Processing, Muscatine, IA. Permeate heated to 175 degrees prior to drying. Ratio of permeate to soy hulls is 3.3:1.
^{C}Alkaline hydrolyzed delactose permeate - pH 5 adjusted (5 parts permeate:2 parts soy oil).

Results are shown in Table 14. All feeds were textured. The comparison between calves with a choice between 7% DPM and 5% RS will be referred to as comparison A. The comparison between calves with a choice between 7% DPM and 3.75% RS will be referred to as comparison B. The comparison between calves with a choice between 7% DPM and 2.5% RS will be referred to as comparison C. The comparison between calves with a choice between 7% DPM and 7% ALDP5 will be referred to comparison D. The comparison between calves with a choice between 7% DPM 3.5% ALDP5 will be referred to as comparison E. The comparison between calves with a choice between 7% DPM and 1.75% ALDP5 will be referred to as comparison F.

TABLE 14

| | | Consumption | | | |
|---|---|---|---|---|---|
| | | lbs/hd/day | Preference | | Preference |
| Comparison | Treatment No. | (As fed basis) | Ratio^{A} | P-value | Incidence^{B} |
| A | CT-8-07-1-Red^{C} | 0.21 | 4.40:1.00 | <0.0001 | 8.3 |
| | CT-8-07-2-Blue^{D} | 0.94 | | | 91.7 |
| B | CT-8-07-1-Red | 0.24 | 4.41:1.00 | <0.0001 | 16.7 |
| | CT-8-07-3-Green^{E} | 1.06 | | | 83.3 |
| C | CT-8-07-1-Red^{C} | 0.28 | 2.02:1.00 | 0.0002 | 31.3* |
| | CT-8-07-4-Orange^{F} | 0.57 | | | 66.7* |
| D | CT-8-07-1-Red | 0.29 | 3.13:1.00 | 0.0001 | 18.8* |
| | CT-8-07-5-Gray^{G} | 0.90 | | | 75.0* |
| E | CT-8-07-1-Red^{C} | 0.21 | 4.40:1.00 | <0.0001 | 8.3 |
| | CT-8-07-6-Yellow^{H} | 0.94 | | | 91.7 |
| F | CT-8-07-1-Red | 0.08 | 14.83:1.00 | <0.0001 | 4.2 |
| | CT-8-07-7-Purple^{I} | 1.19 | | | 95.8 |

^{A}Determined by dividing the intake of the preferred product by that of the less preferred product.
^{B}Percent of feedings that calves preferred each product.
^{C}Current liquid molasses blend (5 parts cane molasses:2 parts soy oil), DPM = Dairy processed molasses
^{D}5% RumaSweet ®, manufactured by LOLP Feed by C.K. Processing, Muscatine, IA. Permeate heated to 175 degrees prior to drying. Ratio of permeate to soy hulls is 3.3:1.
^{E}3.75% RumaSweet ®, manufactured for LOLP Feed by C.K. Processing, Muscatine, IA. Permeate heated to 175 degrees prior to drying. Ratio of permeate to soy hulls is 3.3:1.
^{F}2.5% RumaSweet ®, manufactured for LOLP Feed by C.K. Processing, Muscatine, IA. Permeate heated to 175 degrees prior to drying. Ratio of permeate to soy hulls is 3.3:1.
^{G}7% Alkaline hydrolyzed delactosed permeate - pH adjusted (5 parts permeate:2 parts soy oil).
^{H}3.5% Alkaline hydrolyzed delactosed permeate - pH 5 adjusted (5 parts permeate:2 parts soy oil).
^{I}1.75% Alkaline hydrolyzed delactosed permeate - pH 5 adjusted) 5 parts permeate:2 parts soy oil).
*Both percentages added not equal to 100 due to ties.

Calves in comparison A and B consumed more, had a better preference ratio and preference incidence (P<0.0001) for 5% and 3.75% RumaSweet® compared to 7% DPM. Calves in comparison C consumed slightly more, had better preference ratio and preference incidence (P=0.0002) for 2.5% RumaSweet® compared to 7% DPM. Overall, this shows calves clearly favored the RumaSweet® containing products compared to 7% DPM, with the higher inclusion containing feeds being the definite choice by calves.

Calves in comparisons D, E and F consumed more, had better preference ratio and improved percent preference incidents (P,0.0001) for all ALDP5 containing starters over 7% DPM.

Calf intakes, preference ratios and preference incidences were improved (<0.0001) for ALDP5 containing starters compared to 7% DPM. Delactosed permeate can serve as an alternative to whey permeate in the production of liquid sweetener.

Calf intakes, preference ratios and preference incidences were improved (P<0.0002) for RumaSweet® containing starters compared to 7% DPM. Currently, RS is recommended at the 2.5% inclusion rate. At this inclusion, preference is consistent to that noted for early generation RS (relative to liquid molasses).

Although the present invention has been described with reference to preferred embodiments, workers skilled in the art will recognize that changes may be made in form and detail without departing from the spirit and scope of the invention.

What is claimed is:

1. A method of making a liquid sweetener for animals comprising:
adding amino acids or protein to a lactose containing liquid;
hydrolyzing the lactose containing liquid; and
heating the lactose containing liquid to adjust the moisture content to greater than about 15%.

2. The method of claim 1 wherein the lactose containing liquid is hydrolyzed prior to adding of the amino acids or protein.

3. The method of claim 2 wherein the hydrolyzing is by acid hydrolysis.

4. The method of claim 1 wherein the hydrolyzing is by alkaline hydrolysis.

5. The method of claim 4 wherein the hydrolyzing and adding are done simultaneously.

6. The method of claim 1 wherein the lactose containing liquid is whey is a whey derivative.

7. The method of claim 6 wherein the whey is whey permeate.

8. The method of claim 6 wherein the whey is delactosed whey permeate.

9. The method of claim 1 further comprising mixing the sweetener with oil.

10. The method of claim 9 wherein the sweetener and the oil are combined at a ratio of about 5:2, respectively.

11. The method of claim 1 further comprising adjusting the pH of the sweetener.

12. A method of increasing palatability of animal feed comprising:
coating animal feed with a liquid sweetener wherein the liquid sweetener comprises a hydrolyzed lactose containing liquid combined with amino acids and/or proteins and heated to form the liquid sweetener having a moisture content of at least about 15%.

13. The method of claim 12 further comprising mixing the liquid sweetener with soy oil prior to coating the animal feed.

14. A method of feeding animals comprising:
coating animal feed with a liquid sweetener wherein the liquid sweetener comprises hydrolyzed whey or whey derivative combined with amino acids and/or proteins and heated to form the liquid sweetener having a moisture content of at least about 15%.

15. The method of claim 14 further comprising mixing the liquid sweetener with soy oil prior to coating the animal feed.
